(19) United States
(12) Patent Application Publication
(10) Pub. No.: US 2007/0050405 A1
(43) Pub. Date: Mar. 1, 2007

(54) Method for configuring an automation installation

(75) Inventor: Peter Wiedenberg, Feucht (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 10/578,208

(22) PCT Filed: Oct. 28, 2004
(86) PCT No.: PCT/EP04/52711

§ 371 Date: May 4, 2006

(30) Foreign Application Priority Data
Nov. 4, 2003 (DE) 10351350.7

(51) Int. Cl. G06F 17/00

(52) U.S. Cl. 707/104.1

(57) ABSTRACT

In a method for configuring an automation installation, a provider stores configuration data in a database. A buyer or client can download a copy from the database. Preferably, there is also stored in the database a description that is associated with the configuration data and which is also available for download by the user.

Automation installations often contain a large number of single components communicating with one another. Starting up, maintaining or expanding the installation's functionality requires “configuration phases”. In a configuration phase, the “configuration data” for the automation installation are created. These denote everything including programs, control instructions, etc. which ultimately provide the automation installation with its actual functionality.

The manufacturer of automation components and installations usually provides example programs, standard routines and other auxiliary means which make it easier for the installation operator to create the configuration data. Nevertheless, each user reconfigures the automation installation afresh for his specific application. There are therefore configuration data freshly created in parallel or recurrently by a wide variety of users, and these data often solve or achieve identical or at least very similar problems or objects in the automation installation. A configuration operation of this type is often time-consuming and complex.

It is an aim of the invention to simplify the configuration of an automation installation.

The object is achieved by a method for configuring an automation installation in which a provider stores configuration data in a database. These configuration data can be taken from the database by a buyer as a copy.

If the provider and buyer are both users of an automation installation, for example, then configuration data can be transferred between them. The configuration data from the providing user can be used to support the buyer or the buyer is able to use parts of the configuration data directly for his own purposes in his automation installation. This significantly simplifies and speeds up configuration of the buyer's automation installation.

Over the course of time, the database may accumulate very large volumes of configuration data from various providers, which means that a buyer can take identical or similar solutions from the database for many of his problems and can thus easily and quickly create his configuration data.

Duplications can be effectively avoided in this manner. The buyers as users obtain their automation solutions more quickly. Ideas can also be exchanged between users. The manufacturer of an automation system can also gain access to the configuration data as a buyer and can obtain insights for his further product development from these configuration data. As a provider, the manufacturer of an automation component is able to provide user-prompted, e.g. specifically optimized, solution elements in the database.

In one preferred embodiment, the database is used to store a description associated with the configuration data. This description can be taken from the database by the buyer. By taking and examining the description of configuration data, the buyer obtains a rapid overview of the configuration data provided and can easily decide whether or not they are of use to him. He does not first need to analyze the configuration data himself so as to become clear about the functionality, significance and purpose thereof in slow and laborious fashion.

In a further embodiment of the invention, the buyer transfers a denomination to the database in order to take a copy of the configuration data. This denomination may be an electronic currency, for example, which the buyer receives from the operator of the database in return for a monetary payment to said operator, or money can be transferred directly between bank accounts associated with the buyer and the operator of the database. The buyer therefore pays money to the database for the configuration data. This may be entirely profitable to him, because he himself saves time and effort and hence also money for independent development of the configuration data.

In a further refinement of the invention, a denomination is transferred to the provider of the configuration data for each copy thereof which is taken from the database. The provider is therefore paid for his work which he has invested in creating the configuration data whenever a buyer takes a copy of his configuration data from the database. The provider therefore becomes the service provider for the buyer in a certain way.

The denomination which the provider contains may correspond to the denomination which the buyer transfers, for example. Alternatively, part of the denomination may be withheld by the operator of the database in order to pay him for providing the database. The payment gives providers an incentive to store their created configuration data in the database and in this way to make them available to the other operators of automation installations.

In a further embodiment of the invention, the database is connected to the Internet. This gives providers and buyers in equal measure the opportunity to access the database very easily, since an Internet connection can be regarded as standard today for any user operating an automation installation. The infrastructure for effective and widespread use of the database is therefore already in place.

For a further description of the invention, reference is made to the exemplary embodiments in the drawings, in which, in a respective basic illustration:

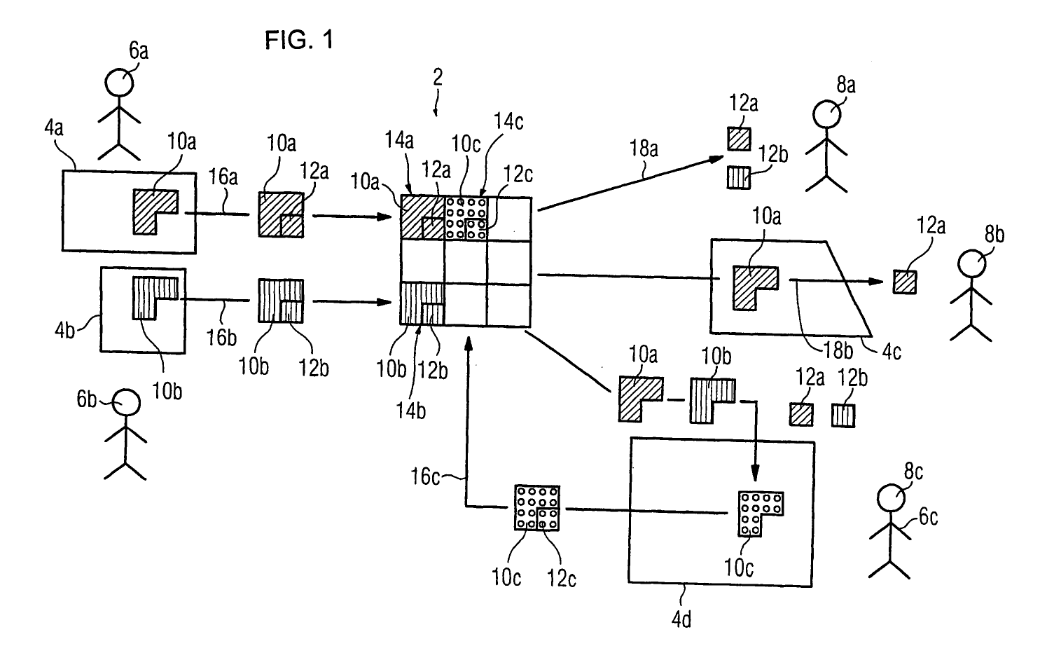

FIG. 1 shows the configuration of an automation installation using a database,

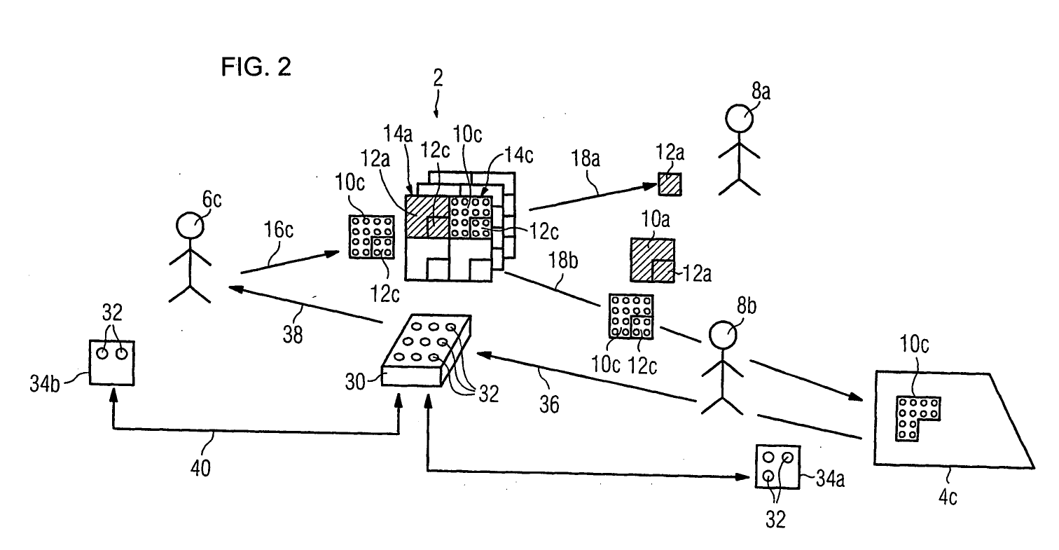

FIG. 2 shows various payment operations when using the database from FIG. 1.

FIG. 1 shows a database 2 for configuration data for automation installations 4a-d. As users of the database 2, there are various providers 6a-c and buyers 8a-c, the provider 6c simultaneously being a buyer 8c.

The provider 6a operates the automation installation 4a. For this, he has created configuration data 10a. The provider 6a attaches a description 12a describing his configuration data 10a to a copy of said configuration data and stores the entire data packet in the database 2 at a storage location 14a therein. This operation is indicated by the arrow line 16a.

The provider 6b has another automation installation 4b, but from the same manufacturer as in the case of the automation installation 4a, for which he has designed different configuration data 10b. He acts as described above for the provider 6a and places his configuration data 10b with the corresponding description 12b at the storage location 14b in the database 2.

The buyer 8a does not yet have an automation installation but before purchasing one wishes to obtain information about the general availability and quality of configuration data 10a,b,c in the database 2 in order to decide whether he will purchase an automation installation like the automation installations 4a,b—namely from the manufacturer thereof. He therefore takes a copy of the descriptions 12a,b from the database 2 on the path indicated by arrow 18a and can study these descriptions in detail.

To simplify the language, the text below also refers to “the data” etc. when strictly copies are meant.

The buyer 8b has just purchased the automation installation 4c—again from the same manufacturer—and wishes to configure it. He takes the description 12a from the database 2 along the path 18b and establishes that said description's associated configuration data 10a meet his needs exactly. He therefore also takes the configuration data 10a from the database 2 on the same path 18b and supplies them to his automation installation 4c.

The buyer 8c takes the descriptions 12a,b from the database 2 along the path 18c. He establishes that the two associated configuration data items 10a,b provide solution elements for his automation installation 4d. He therefore takes the two configuration data items 10a,b from the database 2 along the path 18c. Through his own additional efforts, he combines the configuration data 10a,b and expands them by additional functionalities and alignments to produce configuration data 10c, which he introduces into his automation installation 4d on the path 18c.

To make his created configuration data 10c accessible to other users as well, the former buyer 8c then acts as a provider 6c. He provides the configuration data 10c with a corresponding description 12c and puts the packet comprising configuration data 10c and description 12c into the storage location 14c in the database 2 along the path 16c. Configuration data and descriptions are stored and taken along the paths 16a-c and 18a-c in simple fashion electronically via the Internet in the form of what is known as an upload or download. In this context, the database 2 is in the form of an Internet page which is maintained by an operator (not shown), namely by the manufacturer of the automation installations 4a-d.

FIG. 2 again shows the database 2 from FIG. 1. The operator (not shown) of the database 2 and the manufacturer of the automation installations 4a-d has an account 30 which is associated with the database 2 and in which he manages denominations 32. Descriptions 12a,c can be taken from the database 2 by any buyer 8a,b at no cost and at any time. Even the buyer 8a, who is not yet a customer of the database operator because he has not yet purchased an automation installation from him, is entitled to take descriptions 12a at no cost.

The buyer 8b is also entitled to take descriptions 12a,c from the database at any time at no cost. Since he is also a new customer and has just purchased the automation installation 4c, he is also entitled a free download, that is to say to take configuration data at no cost. He decides to take the configuration data 10a from the database 2. He therefore does not need to pay anything for taking these data along the arrow 18b.

At a later time, the buyer 8b decides to re-equip his automation installation 4c. For this, he also requires new configuration data. He therefore takes the description 12c from the database 2, again at no cost, and finds that the configuration data 10c meet his requirements. This time, however, he can no longer obtain these configuration data on the path 18b at no cost, since he has already made use of his one free download by obtaining the configuration data 10a.

The buyer 8b therefore sets up an account 34a, which is empty at first. In return for payment of a certain sum of money to the operator of the database 2, he receives a transfer to his account 34a of a few denominations 32 from said operator's account 30. The denominations 32 may have the same or different monetary equivalents. By returning a denomination 32 or a plurality of denominations 32 corresponding to the configuration data 10c to the account 30—that is to say by performing a payment operation—, indicated by the arrow 36, he receives the configuration data 10c in return via the path 18b and can then supply them to his automation installation 4c.

The configuration data 10c have previously been created by the provider 6c and have been put into the database 2 with the associated description 12c. They therefore comprise an equivalent provided by the provider 6c, since the latter has invested work time and effort in creating the configuration data 10c.

When the copy 10c has been obtained by the buyer 8b, the operator of the database 2 sets up an account 34b for the provider 6c, if the latter has not yet done this himself, and transfers denominations 32 to this account from his account 30 as payment for the copy 10c of the configuration data from the provider 6c which the buyer 8b has obtained. The denomination 32 transferred to the provider 6c from the account 30 along the path indicated by the arrow 38 may either be the full amount of the denominations paid by the buyer 8b or an amount of denominations 32 which is reduced by a commission for the operator. The provider 6c is now free to use the path indicated by the arrow 40 either to transfer his denominations 32 to the operator's account 30, and to have the corresponding sum of money paid to him from this account, or to have the denominations 32 credited to him when next purchasing a product (not shown) from the operator of the database 2.

The latter way is usually more profitable for the provider 6c.

To pay for configuration data 10a,c, the operator of the database 2 normally has diverse options, only a few of which are mentioned here by way of example: it is conceivable that new customers can obtain a limited number of configuration data items from the database 2 at no cost for purchasing an automation installation, with the operator nevertheless transferring a credit from his own stock to the relevant provider of the configuration data. The operator can even put configuration data into the database 2 and be paid for these data when they are purchased. The operator can give away denominations 32 to buyers' accounts, said denominations in turn not being able to be cashed in, but rather entitling said buyers to a manner of free purchase of configuration data as a result. The opportunity for free purchase may have a time limit.

It is also possible for the provider not to be credited until more than five users have obtained his configuration data.

It is also conceivable to allow the exchange market to be used only by a particular group of people, e.g. by the buyers of a particular manufacturer of automation installations.

1-5. (canceled)

6. A method of configuring an automation installation, which comprises:
storing configuration data in a database by a provider; and
rendering the configuration data available from the database in form of a copy for acquisition by a buyer.

7. The method according to claim 6, which comprises storing in the database a description associated with the configuration data and rendering the description available for acquisition by the buyer.

8. The method according to claim 6, which comprises transferring a given value to the database by the buyer prior to acquiring a copy of the configuration data from the database.

9. The method according to claim 6, which comprises transferring a given value to the provider for each copy of the configuration data acquired from the database.

10. The method according to claim 6, wherein the database is connected to the Internet.
